(19) United States
(12) Patent Application Publication
(10) Pub. No.: US 2025/0358011 A1
(43) Pub. Date: Nov. 20, 2025

(54) OPTICAL REPEATER SYSTEM, AND RELAY METHOD

(71) Applicant: KABUSHIKI KAISHA TOSHIBA, Tokyo (JP)

(72) Inventor: Kyosuke DOBASHI, Higashimurayama Tokyo (JP)

(73) Assignee: KABUSHIKI KAISHA TOSHIBA, Tokyo (JP)

(21) Appl. No.: 19/284,859

(22) Filed: Jul. 30, 2025

Related U.S. Application Data
(63) Continuation of application No. PCT/JP2024/003102, filed on Jan. 31, 2024.

(30) Foreign Application Priority Data
Feb. 3, 2023 (JP) 2023-015434

(51) Int. Cl. H04B 10/29; H04B 10/2575

(52) U.S. Cl. CPC H04B 10/29; H04B 10/25753

(57) ABSTRACT

According to one embodiment, an optical repeater system is provided with a master station including: an inter-master timing comparator that detects delay adjustment amounts respectively corresponding to a plurality of TDD transceivers, based on a switching timing detected by a TDD timing detector and information acquired by a cable delay compensator, and that transmits the delay adjustment amounts to the master station; and a TDD timing delay adjustor that delays signals from the TDD transceivers, using the delay adjustment amounts. The optical repeater system is provided with another master station including: a TDD timing detector that detects switching timings between downlink and uplink for the plurality of TDD transceivers; an intra-master station timing comparator that transmits information on the switching timings between downlink and uplink for the plurality of TDD transceivers; and a TDD timing delay adjustor that delays signals from the TDD transceivers, using the delay adjustment amounts.

### CROSS-REFERENCE TO RELATED APPLICATION

This application is a Continuation Application of PCT Application No. PCT/JP2024/003102, filed Jan. 31, 2024 and based upon and claiming the benefit of priority from Japanese Patent Application No. 2023-015434, filed Feb. 3, 2023, the entire contents of all of which are incorporated herein by reference.

### FIELD

Embodiments described herein relate generally to an optical repeater system, and a relay method.

### BACKGROUND

In recent years, optical repeater systems (distributed antenna systems (DAS)) have been increasingly introduced to eliminate dead zones of mobile communication devices such as cell phones and smartphones. In an optical repeater system, a master unit (MU) coupled to a radio base station of a mobile communication network is linked via an optical line to remote units (RU), which transmit and receive radio signals to and from mobile communication devices. The communication area is expanded by distributing a plurality of remote units throughout the coverage area. This is particularly useful for covering extensive indoor areas, such as large-scale commercial complexes and office buildings.

In general, there are two types of communication schemes between a radio base station and a mobile communication device, namely, the FDD (Frequency Division Duplex) scheme, which uses different frequencies for uplink (UL) and downlink (DL) communications, and the TDD (Time Division Duplex) scheme, which uses a single frequency band in a time divisional manner.

In recent years, carrier aggregation (hereinafter, referred to as CA), which is a technique for improving a communication speed by simultaneously using a plurality of frequency bands, has been put into practical use. For example, in a case where the CA is implemented across frequency bands operating under the TDD scheme, as in 5G (fifth-generation mobile communication system), the 3GPP® specifications stipulate that the timing difference in uplink/downlink (UL/DL) switching between the frequency bands must be within 3 usec.

However, the above stipulation applies to the RF output point of the radio base station and does not take into account cases where an optical repeater system is deployed as part of the radio base station. Therefore, the difference in UL/DL switching timing between the frequency bands may exceed the 3GPP® regulation at the RF output points of the plurality of remote units in the optical repeater system, and the advantages of the CA may not be realized.

In addition, there is a case where a plurality of optical repeater systems (or a plurality of master units) are introduced to cover a common communication area. In this case, there is an issue in that the UL/DL switching timing is not synchronized among the optical repeater systems (master units).

Furthermore, in a case where a plurality of optical repeater systems are expanded, the UL/DL switching timing must be synchronized between the master units in the existing system and the newly added master unit. To achieve this, all master units must be interconnected, which introduces the additional issue of increased circuit complexity with each expansion.

### BRIEF DESCRIPTION OF THE DRAWINGS

FIG. 1 is a diagram illustrating an example configuration of an optical repeater system according to an embodiment, and a conceptual example of a method for correcting a difference in UL/DL switching timing using the system.

FIG. 2 is a functional block diagram illustrating a configuration example of a primary master station and a slave station of the optical repeater system according to the embodiment.

FIG. 3 is a flowchart illustrating an example of processing performed by an intra-master timing comparator and an inter-master timing comparator included in the primary master station of the optical repeater system according to the embodiment.

FIG. 4 is a flowchart illustrating an example of processing performed by a monitoring and control unit included in the primary master station of the optical repeater system according to the embodiment.

FIG. 5 is a functional block diagram illustrating an example of a configuration of a secondary master station and a slave station of the optical repeater system according to the embodiment.

FIG. 6 is a diagram illustrating an example of a primary/secondary configuration of the optical repeater system according to the embodiment.

FIG. 7 is a diagram illustrating an example of a central control system configuration of the optical repeater system according to the embodiment.

### DETAILED DESCRIPTION

An optical repeater system according to one embodiment includes a first master station and a second master station. The first master station and the second master station couple a plurality of base station apparatuses, which are coupled to a mobile communication network and transmit and receive radio signals in mutually different frequency bands, with a plurality of slave stations which perform wireless communication with mobile communication devices. The first master station includes: a first detector that detects the switching timing between downlink and uplink for each of a plurality of first base station apparatuses that are coupled to the first master station; a first delay detector that acquires information on the switching timing between downlink and uplink for each of a plurality of second base station apparatuses that are coupled to the second master station; a first comparator that detects a first delay adjustment amount corresponding to each of the plurality of first base station apparatuses and a second delay adjustment amount corresponding to each of the second base station apparatuses, based on the switching timing detected by the first detector and the information acquired by the first delay detector, and that transmits the second delay adjustment amount to the second master station; and a first adjustor that delays signals from the first base station apparatuses, using the first delay adjustment amount. The second master station includes: a second detector that detects the switching timing between downlink and uplink for each of the plurality of second base station apparatuses; a second comparator that transmits information on the switching timing between downlink and uplink of the plurality of second base station apparatuses; and a second adjustor that delays signals from the second base station apparatuses, using the second delay adjustment amount.

An optical repeater system according to an embodiment of the present invention will now be described with reference to the accompanying drawings. In the embodiments described below, elements assigned with the same symbols perform similar operations, and a redundant description of such elements will be omitted.

### FIRST EMBODIMENT

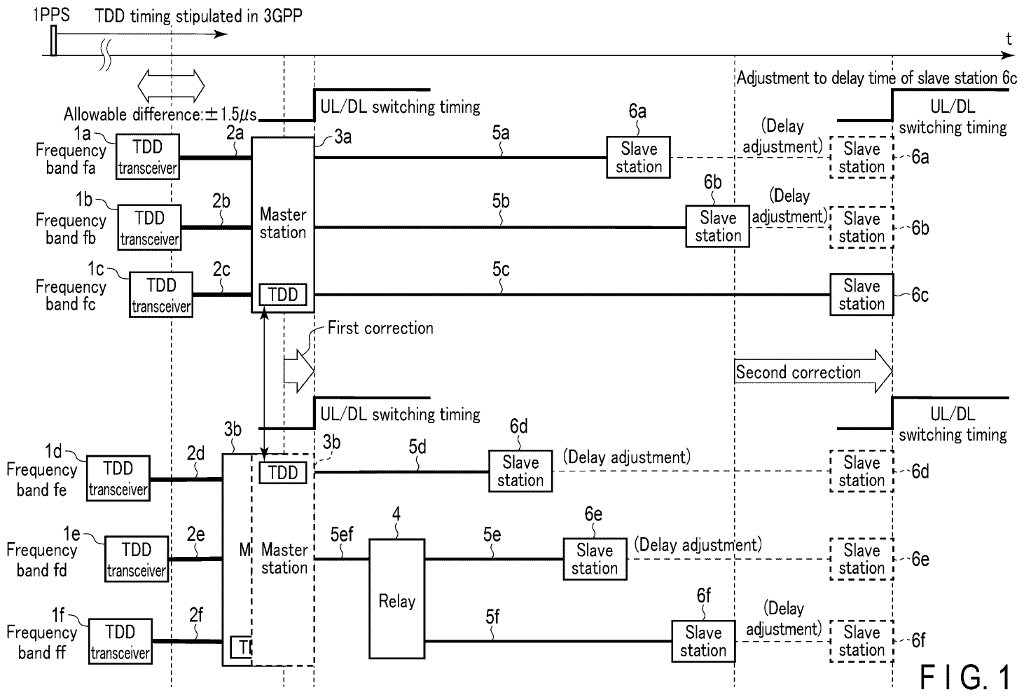

FIG. 1 is a diagram illustrating an example configuration of an optical repeater system according to an embodiment, and a conceptual example of a method for correcting a difference in UL/DL switching timing using the system.

The optical repeater system of the present example embodiment may implement various functions described below by hardware; alternatively, the optical repeater system of the present embodiment may include at least one processor and a memory in which a program executed by the processor is recorded, and various functions described below may be implemented by software or by a combination of software and hardware.

The optical repeater system includes master stations 3a and 3b corresponding to MU; slave stations 6a to 6f corresponding to RU, and a relay 4 (HUB).

In the present embodiment, for the sake of simplicity, a description will be given of an example in which two master stations (3a and 3b) are provided, along with three slave stations (6a to 6c) coupled to the master station 3a and three slave stations (6d to 6f) coupled to the master station 3b. However, the number of master stations and the number of slave stations coupled to each master station are not limited to this example.

The master station 3a and the master station 3b are coupled together, for example, via a twisted pair cable. The master station 3a is coupled via a coaxial cable 2a to a TDD transceiver 1a, which is a base station apparatus coupled to a mobile communication network of a telecommunications carrier, and is also coupled via a coaxial cable 2b to a TDD transceiver 1b.

Similarly, the master station 3b is coupled via coaxial cables 2d, 2e and 2f to TDD transceivers 1d, 1e and 1f, respectively, each of which is a base station apparatus coupled to the mobile communication network of the telecommunications carrier.

For example, in a 100 MHz×4 (4×4 MIMO) configuration, each of the coaxial cables 2a, 2b, 2c, 2d, 2e and 2f includes four coaxial lines, and radio signals of four independent paths are transmitted to the respective base stations (TDD transceivers) via these cables.

In the description below, it is assumed that the TDD transceivers 1a, 1b and 1c transmit and receive radio signals of mutually different frequency bands fa, fb and fc and that the TDD transceivers 1d, 1e and 1f transmit and receive mutually different radio signals of frequency bands fd, fe and ff.

In the present embodiment, for the sake of simplicity, a description will be given of a case where three TDD transceivers (1a to 1c) are coupled to the master station 3a and three TDD transceivers (1d to 1f) are coupled to the master station 3b, but the number of TDD transceivers coupled to each master station is not limited to three.

Even if the TDD transceivers 1a, 1b and 1c are base stations of the same communication carrier, the difference in UL/DL switching timing may occur within a range of 3 usec. Similarly, even if the TDD transceivers 1d, 1e and 1f are base stations of the same communication carrier, the difference in UL/DL switching timing may occur within a range of 3 usec. The TDD transceivers 1a, 1b and 1c are examples of first base station apparatuses, and the TDD transceivers 1d, 1e and 1f are examples of second base station apparatuses.

The master station 3a is capable of detecting the UL/DL switching timing of each of the TDD transceivers 1a, 1b and 1c included in the master station 3a. In addition, the difference in the UL/DL switching timing among the TDD transceivers 1a, 1b and 1c can be adjusted by the master station 3a. Similarly, the master station 3b can detect the UL/DL switching timing of each of the TDD transceivers 1d, 1e and 1f included in the master station 3b. In addition, the difference in the UL/DL switching timing among the TDD transceivers 1d, 1e and 1f can be adjusted by the master station 3b. The same applies to the master station 3c.

Due to the tracking inaccuracies of the GMC (Grandmaster Clock) by the TDD transceiver, the UL/DL switching timing errors of the TDD transceiver, and the variation in the physical lengths of the coaxial cables, there may be a case where a delay difference occurs among the master stations 3a, 3b and 3c even after the adjustment of the switching timing differences.

Accordingly, the optical repeater system according to the present embodiment is configured such that the master station 3a functions as a primary master station, and the master stations 3b and 3c function as secondary master stations. The primary master station recognizes the delay amounts of the TDD transceivers detected by the respective secondary master stations by subtracting, from the UL/DL switching timing information (e.g., a square wave signal) received from the secondary master stations, a delay amount corresponding to the cable length among the master stations. Then, the primary master station sets a common target timing (e.g., the latest UL/DL switching timing) and transmits a corresponding delay amount to each of the secondary master stations, thereby correcting the delay differences associated with the plurality of TDD transceivers coupled to the respective master stations 3a, 3b and 3c (first correction).

The master station 3a and the slave stations 6a, 6b and 6c are coupled via optical fibers 5a, 5b and 5c, respectively, and digital transmission is performed, for example, at a rate of 25 Gbit/s. The master station 3b and the slave station 6d are directly coupled via the optical fiber 5d, and the master station 3b and the slave stations 6e and 6f are coupled via the optical fibers 5e and 5f, with the relay 4 interposed. Similarly, through the optical fibers, digital transmission is performed, for example, at a rate of 25 Gbit/s.

Furthermore, even if the UL/DL switching timing is synchronized at the output end of the master station 3a to the slave stations 6a, 6b and 6c, the difference in UL/DL switching timing may occur among the slave stations 6a, 6b and 6c, due to the differences in the optical fiber length between the master station 3a and the slave stations 6a, 6b and 6c, the transmission delay resulting from the processing delay difference among the devices, or the like. The same applies to the slave stations 6d, 6e and 6f.

The difference in UL/DL switching timing among the slave stations 6a, 6b and 6c in the master station 3a can be adjusted by the master station 3a, and the difference in UL/DL switching timing among the slave stations 6d, 6e and 6f in the master station 3b can be adjusted by the master station 3b.

In the master station 3a, the difference in UL/DL switching timing caused by the transmission delay difference among the slave stations 6a, 6b and 6c can be adjusted. Similarly, in the master station 3b, the difference in UL/DL switching timing caused by the transmission delay difference among the slave stations 6d, 6e and 6f can be adjusted.

However, due to transmission delays caused by differences in optical fiber lengths between the master stations 3a and 3b and processing delay differences in each unit, timing differences in adjustment for the slave stations may occur.

Therefore, in the optical repeater system of the present embodiment, the master station 3a is set as a primary master station, while the master stations 3b and 3c are set as secondary master stations. The primary master station compensates for transmission delays, such as those caused by differences in optical fiber lengths between the master and slave stations, and transmits information on the delay amounts of the slave stations to the secondary master stations. This enables correction of delay differences among the multiple slave stations connected to master stations 3a, 3b, and 3c (second correction).

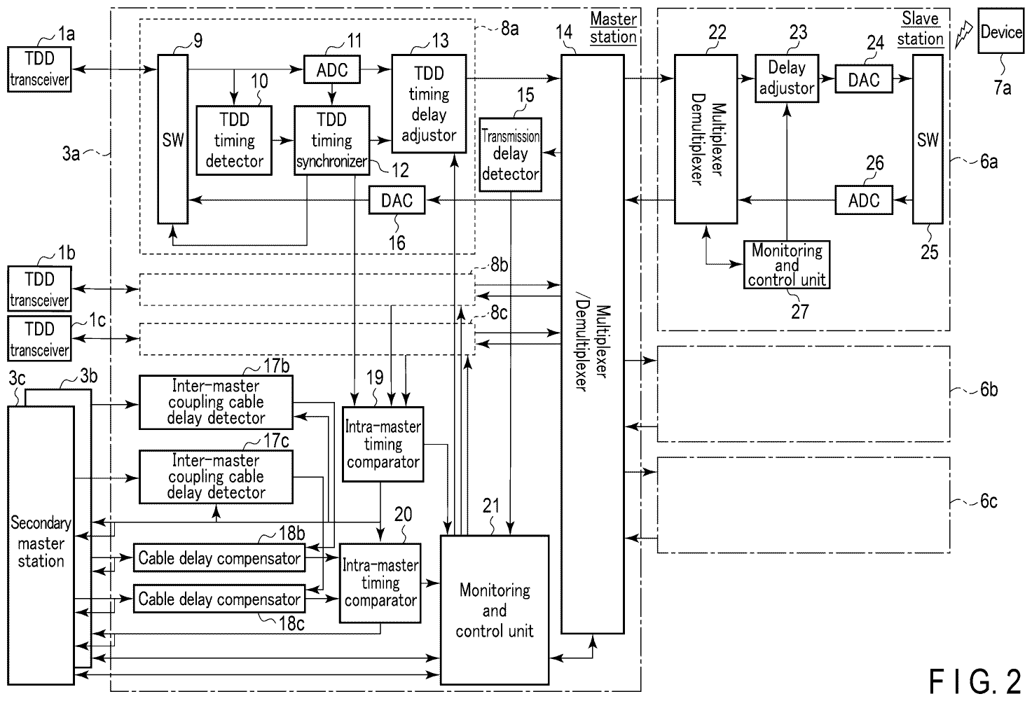

FIG. 2 is a functional block diagram illustrating an example of a configuration of a primary master station and a slave station of the optical repeater system according to the embodiment.

It should be noted that the slave station 6b and the slave station 6c have configurations similar to that of the slave station 6a, so that their illustration and description will be partially omitted.

The primary master station 3a (first master station) includes: signal processing units 8a, 8b and 8c; a multiplexer/demultiplexer 14; a transmission delay detector 15; inter-master coupling cable delay detectors 17b and 17c; cable delay compensators 18b and 18c; an intra-master timing comparator 19; an inter-master timing comparator 20; and a monitoring and control unit 21.

The signal processing unit 8a is coupled to the TDD transceiver 1a via the coaxial cable 2a, the signal processing unit 8b is coupled to the TDD transceiver 1b via the coaxial cable 2b, and the signal processing unit 8c is coupled to the TDD transceiver 1c via the coaxial cable 2c. Via the coaxial cables 2a, 2b and 2c, the signal processing units 8a, 8b and 8c send and receive radio signals exchanged between the TDD transceivers 1a, 1b and 1c and the mobile communication device 7a.

The signal processing unit 8a includes a UL/DL changeover switch (SW) 9, a TDD timing detector 10, an A/D converter (ADC) 11, a TDD timing synchronizer 12, a TDD timing delay adjustor 13, and a D/A converter (DAC) 16. Since the signal processing unit 8b and the signal processing unit 8c have configurations similar to that of the signal processing unit 8a, the details thereof will be omitted. In the description below, unless otherwise specified, the description of the signal processing unit 8a can be replaced with the description of the signal processing unit 8b and the signal processing unit 8c as appropriate.

The UL/DL changeover switch 9 switches the timing of uplink and downlink operations with the TDD transceiver 1a in synchronization with a timing signal transmitted from a TDD timing synchronizer 12 described later.

The TDD timing detector 10 detects an RF signal received from the TDD transceiver 1a and identifies the switching timing between uplink and downlink operations. In a case where detection by the TDD timing detector 10 is performed, the TDD timing synchronizer 12 outputs a timing signal such that the UL/DL changeover switch 9 temporarily continues the downlink operation. The TDD timing detector 10 is an example of the first detector.

The A/D converter 11 down-converts an RF signal received from the TDD transceiver 1a into a baseband signal, then performs A/D conversion, and outputs the baseband signal to the TDD timing delay adjustor 13.

The TDD timing synchronizer 12 generates a timing signal (pulse signal) synchronized after checking the periodicity of the UL/DL switching timing detected by the TDD timing detector 10, and outputs that timing signal to the UL/DL changeover switch 9, the TDD timing delay adjustor 13, and the intra-master timing comparator 19.

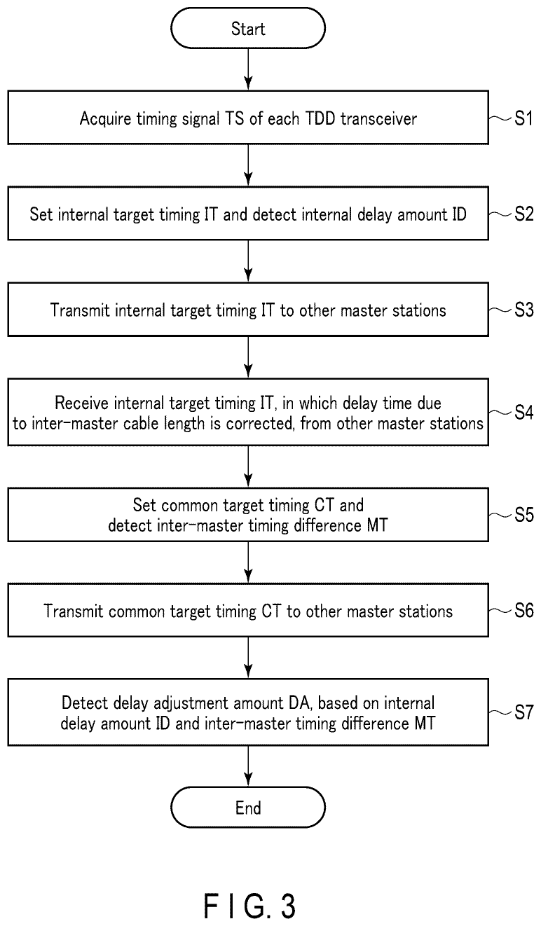

In the description below, the details of the processing performed by the intra-master timing comparator 19 and the inter-master timing comparator 20 will be described with reference to FIG. 3.

FIG. 3 is a flowchart illustrating an example of processing performed by the intra-master timing comparator and the inter-master timing comparator included in the primary master station of the optical repeater system according to the embodiment.

The intra-master timing comparator 19 acquires timing signals output from the signal processing units 8a, 8b and 8c (Step S1), and compares the timing signals with each other. For the sake of simplicity, the timing signal output from the signal processing unit 8a will be denoted by TS1, the timing signal output from the signal processing unit 8b will be denoted by TS2, and the timing signal output from the signal processing unit 8c will be denoted by TS3.

The intra-master timing comparator 19 compares the three timing signals TS1, TS2, and TS3 with each other, and detects internal delay amounts ID1, ID2 and ID3 for correcting the delay differences among the TDD transceivers 1a, 1b and 1c (Step S2).

The internal delay amounts ID1, ID2 and ID3 correspond to adjustment amounts for transmission and reception timings, and are used by the signal processing units 8a, 8b and 8c to synchronize the switching timings of signals from the TDD transceivers 1a, 1b and 1c with a predetermined reference timing.

More specifically, for example, in the internal delay difference detection process, the intra-master timing comparator 19 sets the latest switching timing (or a predetermined timing based on it) as an internal target timing IT1 in order to align with the TDD transceiver having the latest switching timing. The intra-master timing comparator 19 then detects the difference between this internal target timing IT1 and the timing signals detected by the signal processing units 8a, 8b and 8c as internal delay amounts ID1, ID2 and ID3 (Step S2).

The intra-master timing comparator 19 transmits the internal target timing IT1 and the internal delay amounts ID1, ID2 and ID3 to the inter-master timing comparator 20, and transmits the internal target timing IT1 to the master stations 3b and 3c and the inter-master coupling cable delay detectors 17b and 17c (Step S3). The intra-master timing comparator 19 is an example of the first comparator.

The inter-master coupling cable delay detector 17b acquires the output signal of the internal target timing IT1 transmitted by the intra-master timing comparator 19 to the master station 3b, and the input signal that is looped back to the master station 3a upon arrival at the master station 3b. Similarly, the inter-master coupling cable delay detector 17c acquires the output signal of the internal target timing IT1 transmitted by the intra-master timing comparator 19 to the master station 3c, and the input signal that is looped back to the master station 3c upon arrival at the master station 3a.

The inter-master coupling cable delay detectors 17b and 17c detect phase differences between the output signals and the input signals acquired by the respective units. In the description below, the phase difference between the output signal and the input signal detected by the inter-master coupling cable delay detectors 17b will be referred to as PD1, and the phase differences between the output signal and the input signal detected by the inter-master coupling cable delay detector 17c will be referred to as PD2. The phase differences PD1 and PD2 are used to calculate the delay times caused by the cable lengths between the master station 3b and the master station 3a, and between the device 3c and the master station 3a, respectively.

The inter-master coupling cable delay detector 17b sends the phase difference PD1 to the cable delay compensator 18b. The inter-master coupling cable delay detector 17c sends the phase difference PD2 to the cable delay compensator 18c.

The cable delay compensator 18b receives the phase difference PD1 and the internal target timing IT2 transmitted from the master station 3b. The cable delay compensator 18b calculates a delay time caused by the cable length between the master station 3a and the master station 3b, based on the phase difference PD1, and corrects the internal target timing IT2 using the calculated delay time. The cable delay compensator 18c receives the phase difference PD2 and the internal target timing IT3 transmitted from the master station 3c. The cable delay compensator 18c calculates a delay time caused by the cable length between the master station 3a and the master station 3c, based on the phase difference PD2, and corrects the internal target timing IT3 using the calculated delay time. The details of the processing performed by the secondary master stations (master stations 3b and 3c) will be described later.

The cable delay compensators 18b and 18c transmit the corrected internal target timing IT2 and the corrected internal target timing IT3 to the inter-master timing comparator 20. The inter-master coupling cable delay detectors 17b and 17c and the cable delay compensators 18b and 18c are examples of the first delay detector.

The inter-master timing comparator 20 compares the received (acquired) internal target timings IT1, IT2 and IT3 with each other (Step S4). The inter-master timing comparator 20 sets a common target timing CT1 as a comparison result, and detects an inter-master timing difference MT1 (Step S5).

More specifically, in the inter-master timing difference detection process, the inter-master timing comparator 20 sets the latest internal target timing (or a predetermined timing based on it) among the internal target timings IT1, IT2 and IT3 as a common target timing CT1. Then, the inter-master timing comparator 20 detects the difference between the common target timing CT1 and the internal target timing IT1 as an inter-master timing difference MT1, in order to align with the master station having the latest internal target timing (Step S5).

The inter-master timing comparator 20 transmits the common target timing CT1 to the master station 3b and the master station 3c (Step S6). The master station 3b detects a difference between the received common target timing CT1 and the internal target timing IT2 as an inter-master timing difference MT2. The master station 3c detects a difference between the received common target timing CT1 and the internal target timing IT3 as an inter-master timing difference MT3.

The inter-master timing comparator 20 may detect an inter-master timing difference MT2, which is the difference between the common target timing CT1 and the internal target timing IT2, and an inter-master timing difference MT3, which is the difference between the common target timing CT1 and the internal target timing IT3.

In the total delay difference detection process, the inter-master timing comparator 20 detects delay adjustment amounts DA1, DA2 and DA3 (first delay adjustment amounts) for use in the signal processing units 8a, 8b and 8c, based on the internal delay amounts ID1, ID2 and ID3 detected in the internal delay difference detection process and the inter-master timing difference MT1 detected in the inter-master timing difference detection process. The detected delay adjustment amounts are then transmitted to the monitoring and control unit 21 (Step S7).

The inter-master timing comparator 20 may detect delay adjustment amounts DA7, DA8 and DA9 (second delay adjustment amounts) for use in the signal processing units 28a, 28b and 28c for delay adjustment, based on the internal delay amounts ID7, ID8 and ID9 transmitted from the master station 3b and the inter-master timing difference MT2 detected in the inter-master timing difference detection process, and transmit the detected delay adjustment amounts to the master station 3b. The same may apply to the master station 3c. It should be noted that the inter-master timing comparator 20 is an example of the first comparator.

The delay adjustment amounts DA1, DA2 and DA3 are information for correcting both the delay difference among the TDD transceivers 1a, 1b and 1c in the master station and the delay difference among the master stations 3a, 3b and 3c.

The monitoring and control unit 21 transmits the delay adjustment amounts DA1, DA2 and DA3 to the signal processing units 8a, 8b and 8c, respectively. The TDD timing delay adjustor 13 applies a delay based on the delay adjustment amount DA1 received from the monitoring and control unit 21 to the output of the A/D converter 11, and adjusts the UL/DL switching timing accordingly. The monitoring and control unit 21 is an example of a first control unit, and the TDD timing delay adjustor 13 is an example of the first adjustor.

The multiplexer/demultiplexer 14 multiplexes the signals output from the TDD timing delay adjustors 13 of the signal processing units 8a, 8b and 8c, converts the multiplexed signals into optical signals, and transmits the optical signals to the slave stations 6a, 6b and 6c via the optical fibers 5a, 5b and 5c.

The multiplexer/demultiplexer 14 receives optical signals from the slave stations 6a, 6b and 6c via the optical fibers 5a, 5b and 5c, and performs photoelectric conversion to extract digital signals. The digital signals are converted into analog signals by the D/A converter (DAC) 16, up-converted into radio frequency signals, and transmitted to the TDD transceivers 1a, 1b and 1c via the UL/DL changeover switch 9 and the coaxial cables 2a, 2b and 2c.

The transmission delay detector 15 detects a transmission delay amount between the master station 3a and the slave stations 6a, 6b and 6c (which is the sum of the device delay time and the delay time caused by the optical transmission path length), using the section of the transmission frame allocated for delay measurement. The transmission delay detector 15 transmits the transmission delay amount to the monitoring and control unit 21.

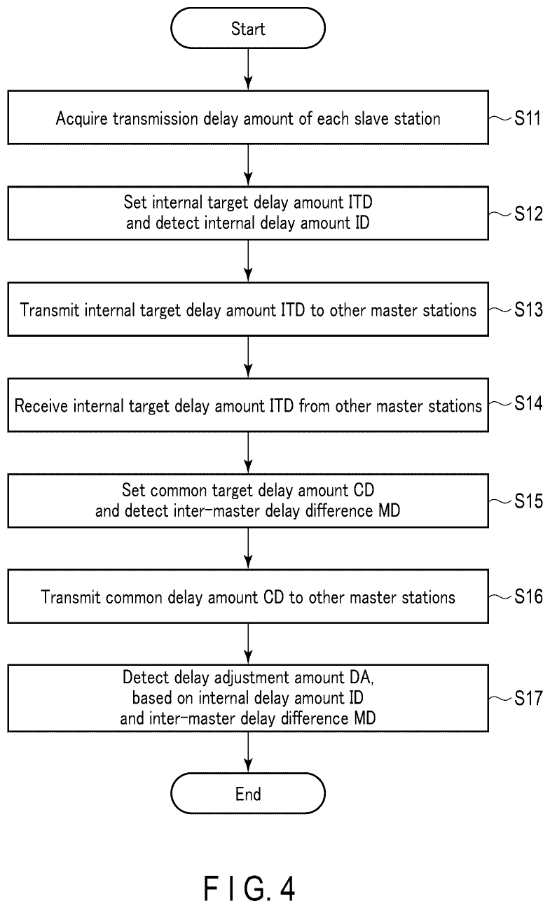

The details of the processing performed by the monitoring and control unit will be described below with reference to FIG. 4.

FIG. 4 is a flowchart illustrating an example of processing performed by the monitoring and control unit included in the primary master station of the optical repeater system according to the embodiment.

In the internal transmission difference detection process, the monitoring and control unit 21 receives (acquires) transmission delay amounts corresponding to the signal processing units 8a, 8b and 8c from the transmission delay detector 15. That is, the monitoring and control unit 21 acquires the transmission delay amounts detected for the slave stations 6a, 6b and 6c (Step S11).

The monitoring and control unit 21 compares the transmission delay amounts corresponding to the slave stations 6a, 6b and 6c with each other, and detects the internal delay amounts ID4, ID5 and ID6 for correcting the transmission delay difference among the slave stations 6a, 6b and 6c (Step S12).

The internal delay amounts ID4, ID5 and ID6 correspond to the adjustment amounts for the transmission delays in the slave stations 6a, 6b and 6c, respectively, in order to align these delay amounts with a predetermined reference delay amount.

In more detail, for example, the monitoring and control unit 21 sets the largest transmission delay amount (or a predetermined value based on it) as an internal target delay amount ITD1, in order to align with the slave station having the greatest delay (the slave station 6c in the example shown in FIG. 1). Then, the monitoring and control unit 21 detects the differences between the internal target delay amount ITD1 and the transmission delay amounts of the slave stations 6a, 6b and 6c as internal delay amounts ID4, ID5 and ID6, respectively (Step S12).

The monitoring and control unit 21 transmits the internal target delay amount ITD1 to the master stations 3b and 3c (Step S13). The monitoring and control unit 21 receives (acquires) an internal target delay amount ITD2 from the master station 3b and an internal target delay amount ITD3 from the master station 3c (Step S14).

The monitoring and control unit 21 compares the internal target delay amount ITD1 with the acquired internal target delay amounts ITD2 and ITD3. The monitoring and control unit 21 detects an inter-master delay difference MD1 as a result of the comparison (Step S15).

In more detail, for example, in the process of detecting an inter-master transmission difference, the monitoring and control unit 21 sets the largest internal target delay amount (or a predetermined delay amount based on it) as a common target delay amount CD1 in order to align with the master station having the greatest delay amount, and detects the difference between the common target delay amount CD1 and the internal target delay amount ITD1 as the inter-master delay difference MD1 (Step S15).

The monitoring and control unit 21 transmits the common target delay amount CD1 to the master station 3b and the master station 3c (Step S16). The master station 3b detects the difference between the received common target delay amount CD1 and the internal target delay amount ITD2 as an inter-master delay difference MD2. The master station 3c detects the difference between the received common target delay amount CD1 and the internal target delay amount ITD3 as an inter-master delay difference MD3.

In a total transmission difference detection process, the monitoring and control unit 21 detects delay adjustment amounts DA4, DA5 and DA6 (third delay adjustment amounts) for use in each of the slave stations 6a, 6b, 6c for adjustment of the transmission delay, based on the internal delay amounts ID4, ID5 and ID6 detected in the internal transmission difference detection process and the inter-master delay difference MD1 detected in the inter-master transmission difference detection process, and transmits them to the corresponding slave stations 6a, 6b and 6c (Step S16).

The monitoring and control unit 21 may detect delay adjustment amounts DA10, DA11, DA12 for use in the slave stations 6d, 6e and 6f for adjustment of the transmission delay, based on the internal delay amounts ID10, ID11 and ID12 acquired from the master station 3b and the inter-master delay difference MD2 detected in the inter-master transmission difference detection process, and transmit these to the master station 3b. The same may apply to the master station 3c. The monitoring and control unit 21 is an example of a first monitoring and control unit.

The delay adjustment amounts DA4, DA5 and DA6 are information for correcting both the difference in the transmission delay amounts among the slave stations 6a, 6b and 6c of the master station 3a and the difference in the transmission delay amounts among the master stations 3a, 3b and 3c.

The monitoring and control unit 21 transmits the delay adjustment amount DA4 to the slave station 6a via the multiplexer/demultiplexer 14. Similarly, the monitoring and control unit 21 transmits the delay adjustment amounts DA5 and DA6 to the respective slave stations 6b and 6c via the multiplexer/demultiplexer 14.

The master station 3a may be provided with a judgment unit. For example, in a case where the difference in UL/DL switching timing is detected as being within 3 μsec (or within an arbitrary time), based on the internal delay amount and inter-master timing difference detected by the inter-master timing comparator 20 and the internal delay amount and inter-master delay difference detected by the monitoring and control unit 21, the judgment unit may instruct (notify) the master stations 3a, 3b and 3c not to perform delay adjustment.

The judgment unit may be configured to include a first judgment unit and a second judgment unit. In a case where the difference in UL/DL switching timing is detected as being within 3 μsec (or within an arbitrary time), based on the internal delay amount and inter-master timing difference detected by the inter-master timing comparator 20, the first judgment unit instructs (notifies) the master stations 3a, 3b and 3c not to perform delay adjustment. In a case where the difference in UL/DL switching timing is detected as being within 3 μsec (or within an arbitrary time), based on the internal delay amount and inter-master delay difference detected by the monitoring and control unit 21, the second judgment unit instructs (notifies) the master stations 3a, 3b and 3c not to perform delay adjustment.

The slave station 6a includes a multiplexer/demultiplexer 22, a delay adjustor 23, a D/A converter (DAC) 24, a UL/DL changeover switch (SW) 25, an A/D converter (ADC) 26, and a monitoring and control unit 27.

It should be noted that the slave stations 6b and 6c are configured similarly to the slave station 6a, so that the details thereof will be omitted. In the description below, unless otherwise specified, the description of the slave station 6a can be replaced with the description of the slave stations 6b and 6c as appropriate.

The multiplexer/demultiplexer 22 converts an optical signal into an electrical signal and extracts a multiplexed digital downlink signal.

The monitoring and control unit 27 detects a signal addressed to the slave station 6a from the downlink signal, and detects a delay adjustment amount DA4 included in the signal and transmitted from the monitoring and control unit 21 of the master station 3a, and outputs it to the delay adjustor 23.

The delay adjustor 23 delays the transmission timing of the downlink signal, based on the delay adjustment amount DA4 output from the monitoring and control unit 27, and outputs it to the D/A converter 24. The D/A converter 24 converts the downlink signal to an analog signal, which is used for modulating a carrier wave. The modulated carrier wave is up-converted to a radio frequency signal, and then radiated into space via the UL/DL changeover switch 25 and an antenna.

The mobile communication device 7a performs communication by switching between transmission and reception (uplink/downlink) at a timing based on the radio signal (downlink) received from the slave station 6a. Thus, the RF signal transmitted from the mobile communication device 7a is output to the A/D converter 26 via the antenna and UL/DL changeover switch 25.

The A/D converter 26 down-converts the RF signal received from the mobile communication device 7a to a baseband signal, performs A/D conversion on it, and outputs the resultant digital signal to the multiplexer/demultiplexer 22.

The multiplexer/demultiplexer 22 converts the digital signal output from the A/D converter 26 into an optical signal, multiplexes the optical signal, and transmits it to the master station 3a via the optical fiber 5a.

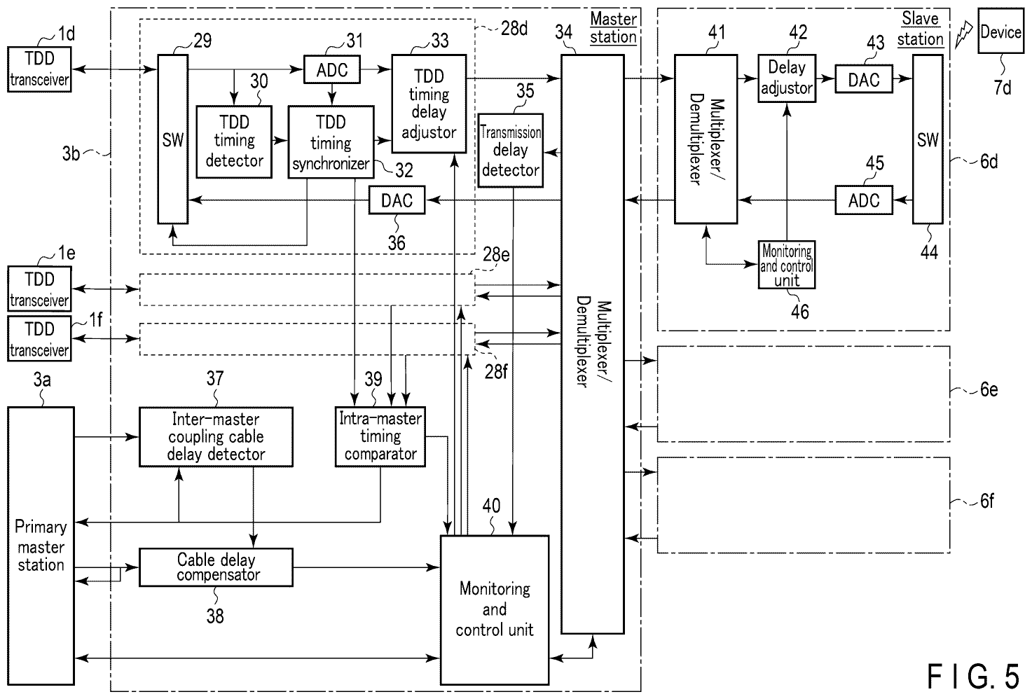

FIG. 5 is a functional block diagram illustrating an example of a configuration of a secondary master station and a slave station of the optical repeater system according to the embodiment.

It should be noted that a description of portions having similar configurations to those of the primary master station 3a will be omitted. Since the secondary master station 3b and secondary master station 3c have similar configurations, the following description will focus on the secondary master station 3b.

The secondary master station 3b (second master station) includes signal processing units 28d, 28e and 28f, a multiplexer/demultiplexer 34, a transmission delay detector 35, an inter-master coupling cable delay detector 37, a cable delay compensator 38, an intra-master timing comparator 39, and a monitoring and control unit 40.

The intra-master timing comparator 39 acquires timing signals output from the signal processing units 28d, 28e and 28f, and compares the timing signals with each other. For the sake of simplicity, the timing signal output from the signal processing unit 28d will be denoted by TS4, the timing signal output from the signal processing unit 28e will be denoted by TS5, and the timing signal output from the signal processing unit 28f will be denoted by TS6. The TDD timing detector 30 included in the signal processing unit 28d is an example of the second detector.

The intra-master timing comparator 39 compares the three timing signals TS4, TS5 and TS6 with each other and detects internal delay amounts ID7, ID8 and ID9 for correcting the delay differences among the TDD transceivers 1d, 1e and 1f.

The internal delay amounts ID7, ID8 and ID9 correspond to adjustment amounts used by the signal processing units 28d, 28e and 28f to adjust the transmission and reception timings so as to synchronize the switching timings of the signals supplied from the TDD transceivers 1d, 1e and 1f with a predetermined reference timing.

More specifically, for example, in the internal delay difference detection process, the intra-master timing comparator 39 sets the latest switching timing (or a predetermined timing based on it) as an internal target timing IT2 in order to align with the TDD transceiver having the latest switching timing. The intra-master timing comparator 19 then detects the difference between this internal target timing IT2 and the timing signals detected by the signal processing units 28d, 28e and 28f as internal delay amounts ID7, ID8 and ID9.

The intra-master timing comparator 39 transmits the internal target timing IT2 to the monitoring and control unit 40, the master station 3a, and the inter-master coupling cable delay detector 37, and transmits the internal delay amounts ID7, ID8, ID9 to the monitoring and control unit 40. The intra-master timing comparator 39 is an example of the second comparator.

Furthermore, the master station 3b receives a common target timing CT1 transmitted by the master station 3a, causes the cable delay compensator 38 to correct the delay time due to the cable length between master stations 3a and 3b, and transmits the corrected delay time to the monitoring and control unit 40. The monitoring and control unit 40 detects the difference between the common target timing CT1 and the internal target timing IT2 as an inter-master timing difference MT2, and further detects (calculates) delay adjustment amounts DA7, DA8 and DA9 (second delay adjustment amounts) from the internal delay amounts ID7, ID8 and ID9 and the inter-master timing difference MT2. The delay adjustment amounts DA7, DA8 and

DA9 are information for correcting both the delay difference among the TDD transceivers 1d, 1e and 1f in the master station 3b and the delay difference among the master stations 3a, 3b and 3c. It should be noted that the monitoring and control unit 40 is an example of a second monitoring and control unit.

The monitoring and control unit 40 transmits the delay adjustment amounts DA7, DA8 and DA9 corresponding to the signal processing units 28d, 28e and 28f, respectively. The TDD timing delay adjustor 33 applies a delay based on the delay adjustment amount DA7 received from the monitoring and control unit 40 to the output of the A/D converter 31, and adjusts the UL/DL switching timing accordingly. It should be noted that the TDD timing delay adjustor 33 is an example of the second adjustor.

In the internal transmission difference detection process, the monitoring and control unit 40 receives (acquires) transmission delay amounts corresponding to the signal processing units 28d, 28e and 28f from the transmission delay detector 35. That is, the monitoring and control unit 40 acquires the transmission delay amounts respectively detected for the slave stations 6d, 6e and 6f. The monitoring and control unit 40 compares the transmission delay amounts corresponding to the slave stations 6d, 6e and 6f with each other, and detects internal delay amounts ID10, ID11 and ID12 for correcting the transmission delay differences among the slave stations 6d, 6e and 6f.

The internal delay amounts ID10, ID11 and ID12 correspond to the adjustment amounts for the transmission delays in the slave stations 6d, 6e and 6f, in order to align their delay amounts with a predetermined reference delay.

In more detail, for example, the monitoring and control unit 40 sets the largest delay amount (or a predetermined delay amount based on it) as an internal target delay amount ITD2 so as to align the slave station with the largest delay amount, and detects the difference between the internal target delay amount ITD2 and the transmission delay amounts of the slave station 6d, 6e and 6f as the internal delay amounts ID10, ID11 and ID12.

The monitoring and control unit 40 transmits the internal target delay amount ITD2 to the master station 3a. The monitoring and control unit 40 also detects (calculates) delay adjustment amounts DA10, DA11 and DA12, based on a common target delay amount CD1 and the internal delay amounts ID10, ID11 and ID12 received from the master station 3a, and transmits them to the corresponding slave stations 6d, 6e and 6f.

The delay adjustment amounts DA10, DA11 and DA12 (fourth delay adjustment amounts) are information for correcting both the difference in the transmission delay amounts between the master station 3b and slave stations 6d, 6e and 6f, and the difference in the transmission delay amount among the master stations 3a, 3b and 3c.

The monitoring and control unit 40 transmits the delay adjustment amount DA10 to the slave station 6d via the multiplexer/demultiplexer 34. Similarly, the monitoring and control unit 40 transmits the delay adjustment amounts DA11 and DA12 to the corresponding slave stations 6e and 6f via the multiplexer/demultiplexer 34.

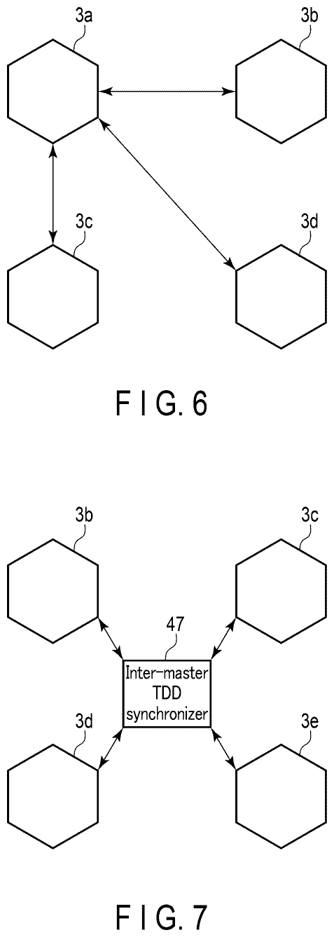

FIG. 6 is a diagram illustrating an example of a primary/secondary configuration of the optical repeater system according to the embodiment.

The master station 3a (primary master station) is coupled via cables to the master station 3b (secondary master station), the master station 3c (secondary master station), and the master station 3d (secondary master station). On the other hand, the secondary master stations are not coupled to each other, and each secondary master station is coupled only to the primary master station.

The above configuration is referred to as a primary/secondary configuration, and the secondary master stations 3b, 3c and 3d transmit the timing signals of the base station apparatuses to which they are coupled and the internal delay amounts of the slave stations to the primary master station 3a. The primary master station 3a detects an inter-master common target timing from the timing signals between the master stations and a common target delay amount from the delay amount, and transmits them to the corresponding secondary master stations 3b, 3c and 3d.

The optical repeater system according to the present embodiment enables synchronization of the RF output timings of the slave stations across a plurality of optical repeater systems. In a case where a plurality of optical repeater systems are expanded, the difference in UL/DL switching timing between the master stations in the existing system and a newly added master station must be synchronized. In the present embodiment, however, all master stations need not be interconnected, and only the circuit configuration of the newly added primary master station needs to be expanded, thereby allowing expansion of the optical repeater system while minimizing circuit complexity.

### SECOND EMBODIMENT

In the optical repeater system of the present embodiment, part of the configuration of the primary master station is extracted and made to function as an inter-master TDD synchronizer. Since the configuration of a secondary master station is similar to that of the first embodiment, a description thereof will be omitted.

FIG. 7 is a diagram illustrating an example of a configuration of a central control system of the optical repeater system according to the embodiment.

The inter-master TDD synchronizer 47 is coupled via cables to a master station 3b (secondary master station), a master station 3c (secondary master station), a master station 3d (secondary master station), and a master station 3e (secondary master station). The inter-master TDD synchronizer 47 is part of the configuration of the primary master station, and includes, for example, inter-master coupling cable delay detectors 17b, 17c, 17d and 17e, cable delay compensators 18b, 18c, 18d and 18e, an inter-master timing comparator 20, a monitoring and control unit 21, a transmission delay detector 15, and a judgment unit.

The inter-master TDD synchronizer 47 performs an internal delay difference process, an inter-master timing difference detection process, a total delay difference detection process, an internal transmission difference detection process, an inter-master transmission difference detection process, and a total transmission difference detection process, which are processes performed by the master station 3a of the first embodiment. In other words, the first correction process and part of the second correction process are performed. The details of the processes are similar to those of the first embodiment.

The optical repeater system according to the present embodiment enables synchronization of the RF output timings of the slave stations across a plurality of optical repeater systems. In a case where a plurality of optical repeater systems are expanded, the difference in UL/DL switching timing between the master stations in the existing system and a newly added master station must be synchronized. However, all master stations need not be interconnected, and only the circuit configuration of the new master station needs to be expanded, thereby allowing expansion of the optical repeater system while minimizing circuit complexity.

While certain embodiments have been described, these embodiments have been presented by way of example only, and are not intended to limit the scope of the invention. Indeed, these embodiments can be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit.

What is claimed is:

1. An optical repeater system comprising a first master station and a second master station,
wherein the first master station and the second master station provide coupling between a plurality of base station apparatuses, which are coupled to a mobile communication network and transmit and receive radio signals of mutually different frequency bands, and a plurality of slave stations which perform wireless communication with mobile communication devices,
the first master station comprises:
a first detector that detects a switching timing between downlink and uplink for each of a plurality of first base station apparatuses coupled to the first master station;
a first delay detector that acquires information on the switching timing between downlink and uplink for each of a plurality of second base station apparatuses coupled to the second master station; and
a first comparator that detects a first delay adjustment amount corresponding to each of the plurality of first base station apparatuses, using a common target timing based on the switching timing detected by the first detector and the information acquired by the first delay detector, and that transmits the common target timing to the second master station; and
a first adjustor that delays signals from the first base station apparatuses, using the first delay adjustment amount, and
the second master station comprises:
a second detector that detects a switching timing between downlink and uplink for each of the plurality of second base station apparatuses;
a second comparator that transmits information on the switching timing between downlink and uplink of the plurality of second base station apparatuses to the first master station;
a second monitoring and control unit that detects a second delay adjustment amount corresponding to each of the plurality of second base station apparatuses, using the common target timing; and
a second adjustor that delays signals from the second base station apparatuses, using the second delay adjustment amount.

2. The optical repeater system according to claim 1, wherein the first comparator detects the first delay adjustment amount corresponding to each of the plurality of first base station apparatuses based on: latest switching timing among switching timings detected by the first detector from the plurality of first base station apparatuses, an internal delay amount, which is a difference between the latest switching timing and the switching timings of the plurality of first base station apparatuses, and the latest switching timing among the switching timings of the plurality of second base station apparatuses, which are obtained from the information acquired by the first delay detector.

3. The optical repeater system according to claim 1, further comprising:
a first determination unit that notifies that delay adjustment is not to be performed in a case where a difference in UL/DL switching timing is detected as being within an arbitrary range, based on the switching timing detected by the first detector and the information acquired by the first delay detector.

4. An optical repeater system comprising a first master station and a second master station,
wherein the first master station and the second master station provide coupling between a plurality of base station apparatuses, which are coupled to a mobile communication network and transmit and receive radio signals of mutually different frequency bands, and a plurality of slave stations which perform wireless communication with mobile communication devices,
the first master station comprises:
a first transmission delay detector that detects transmission delay amounts between the first master station and a plurality of first slave stations coupled to the first master station; and
a first monitoring and control unit that acquires information on transmission delay amounts between the second master station and a plurality of second slave stations coupled to the second master station, detects third delay adjustment amounts respectively corresponding to the plurality of first slave stations, using a common target delay amount based on the transmission delay amounts detected by the first transmission delay detector and the information, transmits the third delay adjustment amounts to the respective first slave stations, and transmits the common target delay amount to the second master station, and
the second master station comprises:
a second transmission delay detector that detects transmission delay amounts between the second master station and the plurality of second slave stations coupled to the second master station; and
a second monitoring and control unit that transmits the information on the transmission delay amounts between the second master station and the plurality of second slave stations, and detects fourth delay adjustment amounts respectively corresponding to the plurality of second slave stations, using the common target delay amount.

5. The optical repeater system according to claim 4, wherein the first monitoring and control unit detects the third delay adjustment amounts respectively corresponding to the plurality of first slave stations based on: a largest transmission delay amount among the transmission delay amounts detected by the first transmission delay detector between the first master station and the plurality of first slave stations; an internal delay amount, which is a difference between the largest transmission delay amount and each of the transmission delay amounts of the plurality of first slave stations, and a largest transmission delay amount among the transmission delay amounts of the plurality of second slave stations, which are obtained from the information acquired by the first transmission delay detector.

6. The optical repeater system according to claim 5, further comprising:
a second determination unit that notifies that delay adjustment is not to be performed in a case where a difference in UL/DL switching timing is detected as being within an arbitrary range, based on the transmission delay amounts detected by the first transmission delay detector and the information acquired by the first monitoring and control unit.

7. A relay method for a first master station and a second master station that provide coupling between a plurality of base station apparatuses which are coupled to a mobile communication network and transmit and receive radio signals of mutually different frequency bands, and a plurality of slave stations which perform wireless communication with mobile communication devices, wherein the relay method for the first master station comprises:
a first detection process of detecting a switching timing between downlink and uplink for each of a plurality of first base station apparatuses coupled to the first master station;
a first delay detection process of acquiring information on the switching timing between downlink and uplink for each of a plurality of second base station apparatuses coupled to the second master station;
a first comparison process of detecting detects first delay adjustment amounts respectively corresponding to the plurality of first base station apparatuses, using a common target timing based on the switching timing detected by the first detector and the information acquired by the first delay detector, and transmitting the common target timing to the second master station; and
a first adjustment process of delaying signals from the first base station apparatuses, using the first delay adjustment amounts, and
the relay method for the second master station comprises:
a second detection process of detecting a switching timing between downlink and uplink for each of the plurality of second base station apparatuses;
a second comparison process of transmitting information on the switching timing between downlink and uplink of the plurality of second base station apparatuses;
a second monitoring and control process of detecting second delay adjustment amounts respectively corresponding to the plurality of second base station apparatuses, using the common target timing; and
a second adjustment process of delaying signals from the second base station apparatuses, using the second delay adjustment amounts.

8. A relay method for a first master station and a second master station that provide coupling between a plurality of base station apparatuses, which are coupled to a mobile communication network and transmit and receive radio signals of mutually different frequency bands, and a plurality of slave stations which perform wireless communication with mobile communication devices,
wherein the relay method for the first master station comprises:
a first transmission delay detection process of detecting transmission delay amounts between the first master station and a plurality of first slave stations coupled to the first master station; and
a first monitoring and control process of acquiring information on transmission delay amounts between the second master station and a plurality of second slave stations coupled to the second master station, detecting third delay adjustment amounts respectively corresponding to the plurality of first slave stations, using a common target delay amount based on the transmission delay amounts detected in the first transmission delay detection process and the information, transmitting the third delay adjustment amounts to the first slave stations, and transmitting the common target delay amount to the second master station, and
the relay method for the second master station comprises:
a second transmission delay detection process of detecting transmission delay amounts between the second master station and the plurality of second slave stations coupled to the second master station; and
a second monitoring and control process of transmitting the information on transmission delay amounts between the second master station and the plurality of second slave stations, and detecting fourth delay adjustment amounts respectively corresponding to the plurality of second slave stations, using the common target delay amount.

9. A recording medium on which a computer program causing a computer to implement the relay method according to claim 7 is stored, the computer serving as the optical repeater system.

10. A recording medium on which a computer program causing a computer to implement the relay method according to claim 8 is stored, the computer serving as the optical repeater system.
